(19) United States
(12) Patent Application Publication
(10) Pub. No.: US 2008/0224074 A1
(43) Pub. Date: Sep. 18, 2008

(54) FLEXIBLE VALVE PLATE AND LOW FRICTION CONTROL SERVO EMPLOYING THE SAME

(75) Inventor: Russell D. Wilfert, Chandler, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/684,763

(22) Filed: Mar. 12, 2007

(51) Int. Cl. F16K 31/126

(52) U.S. Cl. 251/61.1

(57) ABSTRACT

A low friction control servo is provided that includes a housing having an inlet and an outlet. A flexible valve plate is disposed within the housing and includes a curved arm. The curved arm is adapted to flex between (i) an closed position wherein airflow through the outlet is substantially impeded, and (ii) an open position. An actuator is coupled to the housing and engages the curved arm to control the position thereof.

### FIELD OF THE INVENTION

The present invention relates to control servos and, more specifically, to a low friction control servo employing a flexible valve plate.

### BACKGROUND

Control servos are commonly employed in pneumatic valve assemblies to control the flow of pressurized air to the control pressure chamber of a pneumatic actuator, which adjusts the position of the valve (e.g., a butterfly valve plate) within a flowbody. To achieve optimal accuracy, such a control servo may employ a low friction valve mechanism, such as an elongated flexible beam. The elongated flexible beam is mounted in a control servo housing having a control pressure inlet and a control pressure outlet. The control pressure inlet is fluidly coupled to the actuator's control pressure chamber, and the control pressure outlet is fluidly coupled to an ambient source of pressure. One end of the elongated flexible beam is attached to a wall of the housing. The elongated flexible beam extends outwardly from this wall such that a medial portion of the beam lies substantially across the control pressure outlet. When the beam is an unflexed state, the medial portion of the beam covers the outlet and thus prevents pressurized air from flowing therethrough. When the beam flexes, however, the medial portion of the beam lifts off of the outlet and pressurized airflow may be redirected through the control pressure outlet.

The bending of the elongated flexible beam is controlled, at least in part, by a control servo actuator, which may adjust the position of the flexible beam in relation to airflow pressure downstream of the butterfly valve plate. One known control servo actuator includes a plunger, which holds the elongated flexible beam in a desired position to regulate the rate of pressurized airflow through the control pressure outlet. To produce a degaining effect, the plunger may engage the beam's free end (i.e., the end of the beam not attached to the control servo housing) such that a relatively large stroke of the plunger results in a relatively small stroke of the beam's medial portion, which covers the control pressure outlet.

Elongated flexible beams of the type described above may move between open and closed positions with little to no frictional resistance. This permits a control servo employing such a beam to perform control pressure adjustments with an exceptionally high degree of accuracy. However, the length of such an elongated flexible beam is considerable, especially when the elongated flexible beam is utilized to produce a degaining effect in the manner described above. In addition, the considerable length of the elongated flexible beam increases size of the control servo housing and, therefore, the overall weight of the control servo, which may be undesirable when, for example, the control servo is deployed on an aircraft.

It should thus be appreciated that it would be desirable to provide a relatively compact low friction valve mechanism. Similarly, it would be desirable to provide a relatively compact and lightweight control servo mechanism employing such a low friction valve mechanism. Furthermore, it would be desirable if such a low friction valve mechanism were capable of producing a degaining effect. Other desirable features and characteristics of the present invention will become apparent from the subsequent detailed description of the invention and the appended claims, taken in conjunction with the accompanying drawings and this background of the invention.

### BRIEF SUMMARY

A low friction control servo is provided that includes a housing having an inlet and an outlet. A flexible valve plate is disposed within the housing and includes a curved arm. The curved arm is adapted to flex between (i) a closed position wherein airflow through the outlet is substantially impeded, and (ii) an open position. An actuator is coupled to the housing and engages the curved arm to control the position thereof.

### BRIEF DESCRIPTION OF THE DRAWINGS

The preferred exemplary embodiment of the present invention will hereinafter be described in conjunction with the appended drawings, where like designations denote like elements, and:

FIG. 1 is a functional view of a butterfly valve assembly employing a low friction control servo;

FIGS. 2 and 3 are cross-sectional views of a conventional low friction control servo employing an elongated flexible beam in closed and open states, respectively;

FIG. 4 is a bottom plan view of the elongated flex beam shown in FIGS. 2 and 3;

FIGS. 5 and 6 are cross-sectional views of a low friction control servo employing a flexible valve plate in closed and open states, respectively, in accordance with an exemplary embodiment of the present invention;

FIG. 7 is a bottom plan view of the first exemplary flexible valve plate shown in FIGS. 5 and 6; and

FIG. 8 is a bottom plan view of a second exemplary flexible valve plate that may be employed by the control servo shown in FIGS. 5 and 6.

### DETAILED DESCRIPTION OF AT LEAST ONE EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary, or the following detailed description.

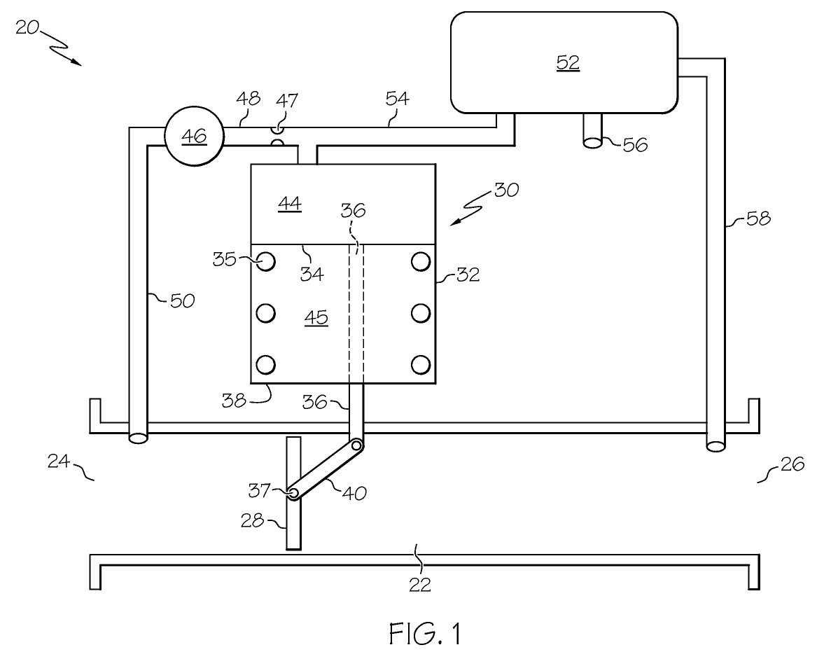

FIG. 1 is a functional view of a butterfly valve assembly 20 including a flowbody 22 having an inlet port 24 and an outlet port 26. A butterfly valve plate 28 is mounted within flowbody 22 and movable between a fully closed position (illustrated), a fully open position, and various intermediate positions. The position of butterfly valve plate 28 is controlled by a pneumatic valve actuator 30, which includes an actuator housing 32 having a flexible diaphragm 34 disposed therein. Diaphragm 34 is coupled to a first shaft 36, which extends through a lower wall 38 of housing 32 and into flowbody 22. Shaft 36 is coupled to a shaft-plate link 40, which is, in turn, coupled to butterfly valve plate 28 (e.g., by way of a second shaft 37, which extends through a wall of flowbody 22). As diaphragm 34 flexes downward and upward, shaft 36 extends and retracts, and butterfly valve plate 28 moves between opened and closed positions, respectively. The position of diaphragm 34 within actuator housing 32 thus generally correlates to the position of butterfly valve plate 28 within flowbody 22.

The position of diaphragm 34 within actuator housing 32, and thus the position of butterfly valve plate 28 within flowbody 22, is influenced by two primary forces: (1) the expansion force of a spring 35 disposed within actuator housing 32, and (2) the pressure within a control pressure chamber 44 formed by diaphragm 34 and actuator housing 32. Spring 35 resides within a cavity 45 provided within actuator housing 32. Cavity 45 may be vented to an ambient pressure source to facilitate the flexing of diaphragm 34. A first end of spring 35 abuttingly engages a lower surface of diaphragm 34, and a second end of spring 35 abuttingly engages lower wall 38 of housing 32. Spring 35 biases diaphragm 34 toward an upward position and, therefore, valve plate 28 toward a closed position. Under the influence of spring 35, diaphragm 34 remains in this position until the pressurized air within control pressure chamber 44 reaches a threshold pressure sufficient to force diaphragm 34 downward and compress spring 35 between diaphragm 34 and lower wall 38. As will be explained more fully below, a low friction control servo 52 is fluidly coupled to control pressure chamber 44 and selectively relieves the pressure therein to control the position of diaphragm 34 and, therefore, the position of butterfly valve plate 28.

A supply pressure regulator 46 is fluidly coupled to control pressure chamber 44 by way of a duct 48, which may include a restrictor 47 therein. Pressure regulator 46 provides duct 48 with a continual flow of air at (or near) a specified pressure (e.g., 20 pound-force per square inch). Pressure regulator 46 draws this pressurized air from a source upstream of butterfly valve plate 28 by way of a duct 50. When the pressurized air supplied by pressure regulator 46 is permitted to continually flow into control pressure chamber 44 without venting by control servo 52, the pressure within control pressure chamber 44 gradually increases to a threshold pressure. At the threshold pressure, the pressurized air forces diaphragm 34 downward. This compresses spring 35 between diaphragm 34 and lower wall 38, and causes butterfly valve plate 28 to transition into an open position. As explained below, control servo 52 may selectively vent the pressurized air within control pressure chamber 44 through duct 54.

Control servo 52 is fluidly coupled to control pressure chamber 44 by way of a duct 54. As indicated above, control servo 52 selectively relieves the pressure within control pressure chamber 44 to adjust the position of diaphragm 34 within actuator housing 32 and, therefore, the position of butterfly valve plate 28 within flowbody 22. Control servo 52 may selectively relieve the pressure within control pressure chamber 44 through a vent 56, which may be fluidly coupled to an ambient pressure source. In the illustrated exemplary embodiment, control servo 52 is depicted as a pneumatic feedback control servo, which is coupled to a downstream source of pressure by way of duct 58; however, it should be understood that control servo 52 may assume any form (e.g., hydraulic or electrical) suitable for selectively bleeding pressurized air from control pressure chamber 44.

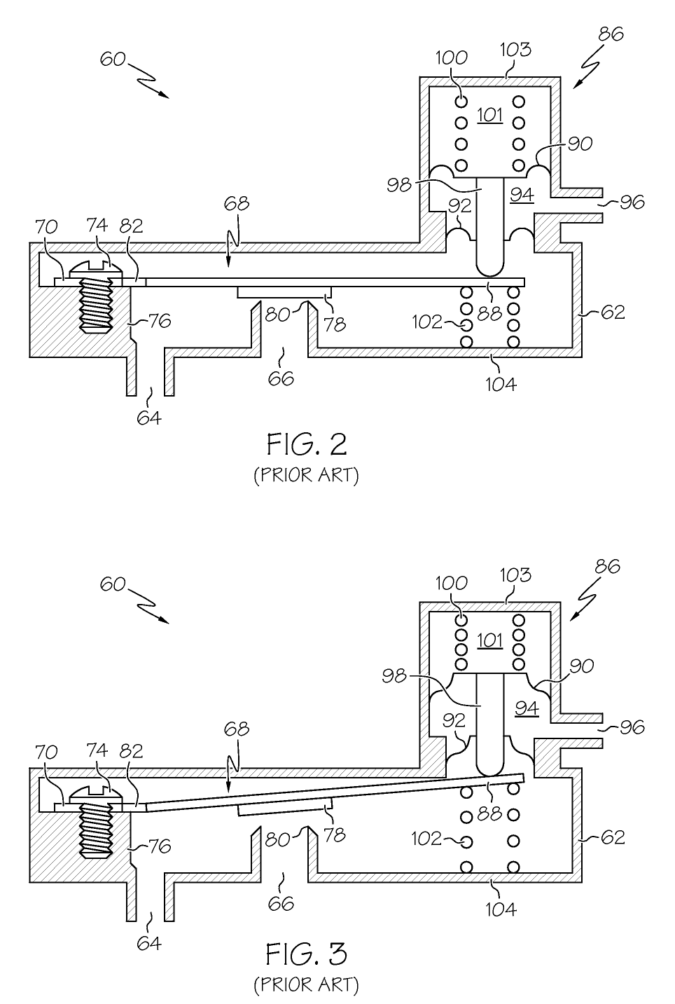

To increase pressure adjustment accuracy, a low friction control servo may be employed as control servo 52. FIGS. 2 and 3 are cross-sectional views of a conventional low friction control servo 60 suitable for use as control servo 52. FIG. 2 illustrates low friction control servo 60 in a fully closed position, and FIG. 3 illustrates control servo 60 in a fully open position. Control servo 60 includes a servo housing 62 having a control pressure inlet 64 and a control pressure outlet 66. As indicated above, control pressure inlet 64 may be fluidly coupled to control pressure chamber 44 via duct 54 (FIG. 1), and control pressure outlet 66 may be fluidly coupled to an ambient pressure source. An elongated flexible beam 68 is disposed within servo housing 62. Elongated flexible beam 68 is positioned over control pressure outlet 66. When in its fully closed (FIG. 2) position, a medial portion of elongated flexible beam 68 covers control pressure outlet 66 and thus obstructs the flow of pressurized air from control pressure inlet 64 to control pressure outlet 66. As a result, control servo 60 does not vent pressurized air from control pressure chamber 44 when in the closed state. However, as described more fully below, elongated flexible beam 68 may bend or flex such that the medial portion of elongated flexible beam 68 lifts off of control pressure outlet 66. This permits pressurized air to vent through control pressure outlet 66, which decreases the pressure within control pressure chamber 44.

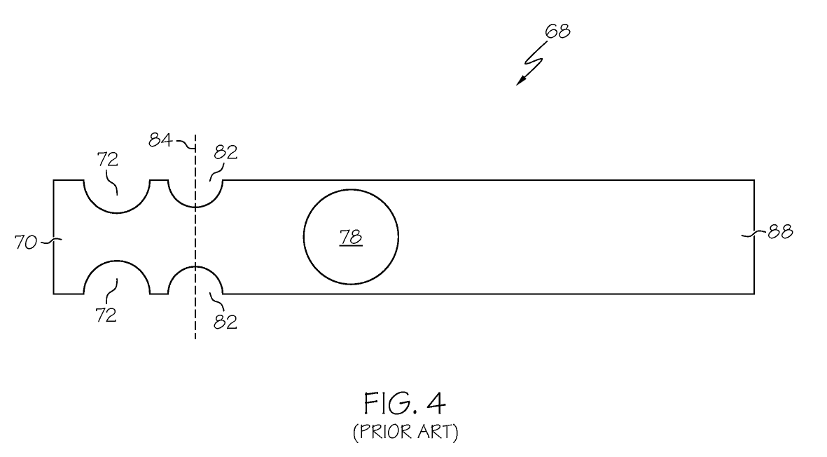

FIG. 4 is a bottom plan view of an exemplary elongated flexible beam 68. Elongated flexible beam 68 includes a first end portion 70 and a second end portion 88. End portion 70 may include one or more retaining bolt slots 72 formed therein. As shown in FIGS. 2 and 3, bolt slots 72 may each receive a fastener (e.g., a bolt) 74 therethrough to mount beam 68 to a shelf 76 provided within servo housing 62. Elongated flexible beam 68 extends outwardly from shelf 76 such that an intermediate portion of beam 68 covers outlet 66 when beam 68 is in the closed position (FIG. 2). To ensure that elongated flexible beam 68 forms a sufficient seal over outlet 66, a stopper (e.g., a molder rubber pad) 78 may be attached to the underside of elongated flexible beam 68. In addition, the walls of housing 62 forming outlet 66 may be tapered as shown in FIGS. 2 and 3 at 80.

Elongated flexible beam 68 is adapted to bend or flex along an axis 84 (FIG. 4). To encourage the flexing of beam 68 along axis 84, one or more notches 82 may provided in end portion 70. When elongated flexible beam 68 bends along axis 84, stopper 78 uncovers control pressure outlet 66 and pressurized air is permitted to flow through outlet 66. A spring 102 is disposed within control servo housing 62. Spring 102 is compressed between end portion 88 of elongated flexible beam 68 and a lower wall 104 of control servo housing 62. Spring 102 biases elongated flexible beam 68 upward toward the flexed (fully open) position shown in FIG. 3. In opposition to spring 102, an actuator 86 is disposed within control servo housing 62 and holds flexible beam 68 in a desired flexed position. In the context of the present invention, the actual implementation of actuator 86 is unimportant; however, for the purposes of illustration, the following will describe actuator 86 as a pneumatic feedback actuator.

Referring still to FIGS. 2 and 3, actuator 86 includes a plunger 98, which extends downward to contact end portion 88 of flexible beam 68. Plunger 98 is coupled to a major diaphragm 90 and a minor diaphragm 92, which are disposed within control servo housing 62 and which cooperate therewith to form a feedback pressure chamber 94. Feedback pressure chamber 94 is fluidly coupled to feedback pressure inlet 96, which is, in turn, fluidly coupled to a downstream pressure source by way of duct 58 (FIG. 1). A cavity 101 is provided within an upper portion of housing 62 and accommodates a first spring 100. If desired, cavity 101 may be vented to an ambient pressure source to facilitate the flexing of diaphragm 90. Spring 100 is compressed between an upper wall 103 of housing 62 and diaphragm 90. Spring 100 biases diaphragm 90, and thus plunger 98, downward toward an extended position shown in FIG. 2.

When the pressure within feedback pressure chamber 94 is at or below a predetermined level, the expansion force of spring 100 is sufficient to overcome that of spring 102. As a result, actuator 86 holds elongated flexible beam 68 in the fully closed position (FIG. 2). However, when the pressure within feedback pressure chamber 94 increases to a threshold pressure, diaphragms 90 and 92 flex upwards as indicated in FIG. 3. Spring 100 compresses, spring 102 expands, and flexible beam 68 bends into an open position (FIG. 3). As explained above, this causes a pressure drop within control pressure chamber 44 (FIG. 1), which results in the movement of butterfly valve plate 28 into a closed position. It should thus be appreciated that control servo 60 is configured to adjust the pressure within control pressure chamber 44, and thus reposition butterfly valve plate 28, so as to adjust the pressure downstream of valve plate 28. It should also be appreciated that elongated flexible beam 68 produces a degaining effect wherein a relatively large stroke of end portion 88 results in a relatively small stroke of the medial portion of beam 68 positioned over outlet 66.

As explained above, conventional control servos (e.g., control servo 60) employing elongated flexible beams (e.g., beam 68) tend to be relatively bulky and heavy due to the excessive length of the elongated flexible beam, especially when the flexible beam is adapted to produce a degaining effect. By comparison, the following describes an exemplary control servo employing a flexible valve plate, which performs the functions of control servo 60, but in a significantly smaller package.

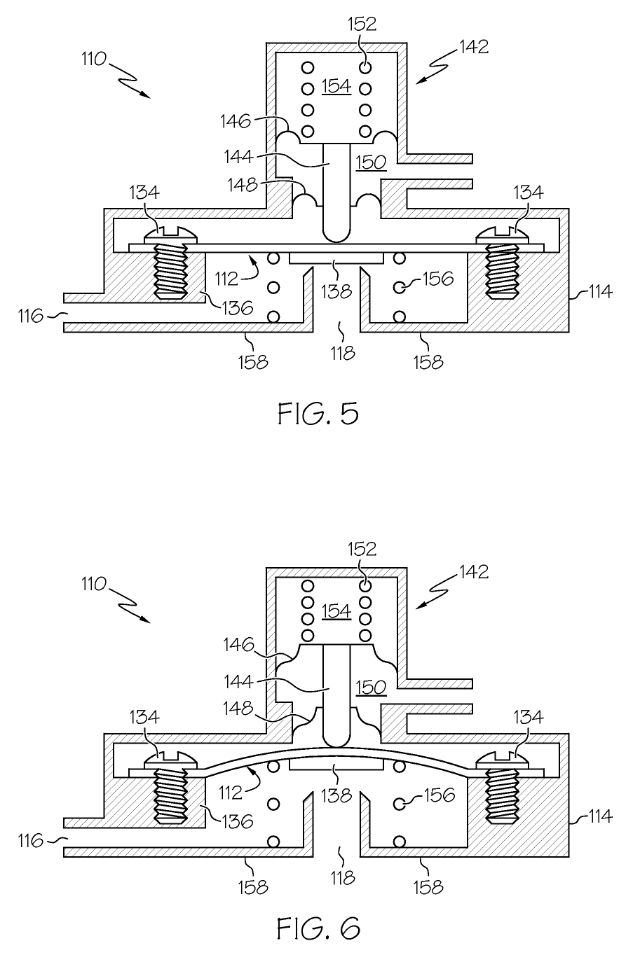

FIGS. 5 and 6 are cross-sectional views of a control servo 110 in fully closed and fully opened positions, respectively, in accordance with an exemplary embodiment of the present invention. Control servo 110 includes a flexible valve plate 112, which is disposed within a control servo housing 114 having a control pressure inlet 116 and a control pressure outlet 118. With respect to butterfly valve assembly 20 (FIG. 1), control servo 110 may be employed as low friction control servo 52. In such a case, control pressure inlet 116 may be fluidly coupled to control pressure chamber 44 via duct 54, and control pressure outlet 118 may be fluidly coupled to an ambient pressure source by way of vent 56.

Flexible valve plate 112 is mounted within servo housing 114 such that flexible valve plate 112 impedes or blocks pressurized airflow through control pressure outlet 118 when in the fully closed position (FIG. 5). For example, as shown in FIGS. 5 and 6, flexible valve plate 112 may extend substantially across control pressure outlet 118 such that a portion of flexible valve plate 112 (e.g., a central portion of plate 112) covers control pressure outlet 118 when in the fully closed position (FIG. 5). This portion of flexible valve plate 112 may flex axially as show in FIG. 6 and lift off control pressure outlet 118 to permit airflow therethrough. The flexed position of valve plate 112 thus generally controls the rate of pressurized airflow through outlet 118 and, consequently, the pressure within control pressure chamber 44 of actuator 30 (FIG. 1).

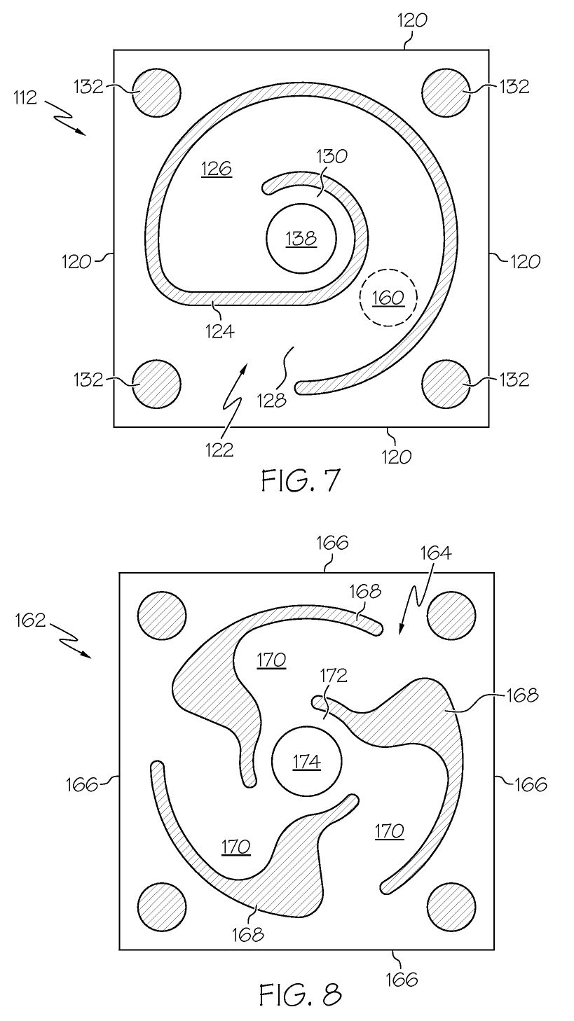

FIG. 7 is a bottom plan view of flexible valve plate 112 in accordance with one exemplary embodiment thereof. As can be seen in FIG. 7, flexible valve plate 112 includes an outer peripheral portion 120 and an inner portion 122, which is coupled to (e.g., integrally formed with) peripheral portion 120. Peripheral portion 120 may surround and enclose inner portion 122. At least one opening or slit 124 is formed through inner portion 122. Slit 124 defines at least one flexible curved beam or arm 126, which includes a proximal end portion 128 and a distal end portion 130. Proximal end portion 128 may be connected to peripheral portion 120, and distal end portion 130 may be substantially unrestrained (i.e., not directly attached to peripheral portion 120). In the exemplary illustrated embodiment, curved arm 126 is generally spiral-shaped (e.g., coiled). When force is applied to distal end portion 130, curved arm 126 may flex away from peripheral portion 120. For example, with reference to FIG. 7, curved arm 126 may flex into the page when force is applied to distal end portion 130. Depending upon the dimensions of flexible valve plate 112, the range of motion of curved arm 126 may be comparable to that of elongated flexible beam 68 discussed above in conjunction with FIGS. 2-4. Flexible valve plate 112 is preferably formed from a sheet of metal or alloy (e.g., stainless steel), and slit 124 is preferably created through inner portion 122 by a stamping or chemical etching process.

In the illustrated exemplary embodiment shown in FIGS. 5 and 6, the fully open position of flexible valve plate 112 (FIG. 5) generally corresponds to the deformed (flexed) position of curved arm 126. In this position, inner portion 122 (in particular, distal end portion 130) is substantially axially offset or displaced from peripheral portion 120. Conversely, the fully closed position of flexible valve plate 112 (FIG. 6) generally corresponds to the non-deformed (un-flexed) position of curved arm 126. In this position, inner portion 122 (in particular, distal end portion 130) is substantially coplanar with peripheral portion 120.

A spring 156 is disposed within control servo housing 114 and compressed between flexible valve plate 112 and a lower wall 158 of housing 114. Spring 156 presses upward on a region of inner portion 122 (e.g., distal end portion 130 of curved arm 126) to bias plate 112 toward the fully open position shown in FIG. 6. In particular, spring 156 may contact the face of curved arm 126 to which stopper 138 is attached. Actuator 142 may contact a second, opposing face of curved arm 126 to hold arm 126, and thus flexible valve plate 112, in a desired position as described more fully below. In FIGS. 5 and 6, actuator 142 is illustrated as a pneumatic feedback actuator; this example notwithstanding, it should be appreciated that actuator 142 may comprise any device suitable for holding inner portion 122 in a desired flexed position, including, but not limited to, a pneumatic actuator, an electrical actuator, a hydraulic actuator, and the like.

Actuator 142 is similar to actuator 86 described above in conjunction with FIGS. 2 and 3; e.g., actuator 142 includes a plunger 144, which is coupled to first and second diaphragms 146 and 148. Diaphragms 146 and 148 cooperate with housing 114 to form a feedback pressure chamber 150, which may be fluidly coupled to a downstream pressure source by way of duct 58 (FIG. 1). A first spring 152 is disposed within a cavity 154 provided within housing 114. If desired, cavity 154 may be vented to an ambient pressure source to facilitate the flexing of diaphragm 146. Spring 152 biases diaphragms 146 and 148, and therefore plunger 144, toward the extended position shown in FIG. 5. When the pressure within feedback pressure chamber 150 is at or below a predetermined level, the expansion force of spring 152 is sufficient to overcome the expansion force of spring 156. As a result, actuator 142 holds flexible valve plate 112 in the fully closed position (FIG. 5). However, when the pressure within feedback pressure chamber 150 increases to a threshold pressure, diaphragms 146 and 148 flex upwards, spring 156 expands, and inner portion 122 of flexible valve plate 112 flexes upward to an open position, such as the fully open position illustrated in FIG. 6. When the pressure within feedback pressure chamber 150 again falls below the threshold pressure, spring 152 expands, plunger 144 moves downward, and flexible valve plate 112 returns to the fully closed (un-flexed) position shown in FIG. 5.

To facilitate the mounting of flexible valve plate 112 within servo housing 114, one or more apertures 132 (FIG. 7) may be provided through peripheral portion 120. A fastener may be inserted through each of apertures 132 to mount flexible valve plate 112 within servo housing 114. For example, as shown in FIGS. 5 and 6, a plurality of bolts 134 may attach peripheral portion 120 to one or more shelves 136 provided within servo housing 114. When flexible valve plate 112 is mounted within servo housing 114 in this manner, a region of inner portion 122 resides over control pressure outlet 118. As explained above, this region sealingly engages control pressure outlet 118 when flexible valve plate 112 is in the fully closed position shown in FIG. 5. As was the case previously, a stopper (e.g., a molded rubber pad) 138 may be coupled to this region to ensure that an adequate seal is formed over outlet 118. In the illustrated embodiment, it is distal end portion 130 of curved arm 126 that sealingly engages outlet 118 when valve plate 112 is in the fully closed position (FIG. 5), although this may not always be the case. For example, as indicated in FIG. 7 at 160, flexible valve plate 112 may be positioned such that a medial portion of curved arm 126 may selectively cover outlet 118. In this case, plunger 144 may still engage distal end portion 130 of curved arm 126 to produce a degaining effect wherein the stroke of distal end portion 130 is considerably larger than that of the medial portion disposed over outlet 118.

Although the foregoing has described an exemplary embodiment of a flexible valve plate including a single coiled arm, it should be understood that the flexible valve plate may assume any form suitable for permitting the axial displacement of the inner portion relative to the outer peripheral portion. For example, the flexible valve plate may include two or more arms of various shapes and dimensions. To further illustrate this point, FIG. 8 is a bottom view of a flexible valve plate 162 having an inner portion 164 and an outer peripheral portion 166 coupled thereto (e.g., integrally formed therewith). Inner portion 164 includes three openings or slits 168 therein, which cooperate to define three curved arms 170 in inner portion 164. At their proximal ends, curved arms 170 are connected to peripheral portion 166. At their distal ends, arms 170 join together to form a common central portion 172. When flexible valve plate 162 is disposed within a control servo housing (e.g., housing 114 described above in conjunction with FIGS. 5 and 6), central portion 172 may reside over and selectively cover the control pressure outlet (e.g., control pressure outlet 118). A stopper 174 may consequently be mounted on central portion 172 as shown in FIG. 8. Collectively, curved arms 170 form a triskelion pattern and permit the axial flexing of inner portion 164 relative to outer peripheral portion 166.

It should thus be appreciated that there has been provided a relatively compact low friction valve mechanism (i.e., a flexible valve plate), which, in certain embodiments, may produce a degaining effect. It should further be appreciated that a relatively compact and lightweight control servo mechanism has also been provided employing such a flexible valve plate. Of course, the foregoing exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A low friction control servo, comprising:
a housing having an inlet and an outlet;
a flexible valve plate disposed within said housing, said flexible valve plate including at least one curved arm configured to flex between (i) an closed position wherein airflow through said outlet is substantially impeded, and (ii) an open position; and
an actuator coupled to said housing and configured engage said curved arm to control the position thereof.

2. A low friction control servo according to claim 1 wherein said flexible valve plate comprises:
a peripheral portion; and
an inner portion coupled to said peripheral portion, said inner portion having at least one slit therein defining said curved arm.

3. A low friction control servo according to claim 2 further comprising a fastener attaching said peripheral portion to said housing.

4. A low friction control servo according to claim 1 wherein said curved arm is disposed over said outlet, said outlet being covered by a region of said curved arm when in the closed position.

5. A low friction control servo according to claim 4 further comprising a stopper attached to said region.

6. A low friction control servo according to claim 5 wherein said region resides on a distal portion of said curved arm.

7. A low friction control servo according to claim 5 wherein said region resides on a medial portion of said curved arm.

8. A low friction control servo according to claim 4 wherein said flexible valve plate is configured to have a degaining effect wherein the stroke of said region is less than the stroke of said actuator.

9. A low friction control servo according to claim 4 wherein said actuator engages said curved arm proximate said region.

10. A low friction control servo according to claim 2 wherein said curved arm comprises:
a proximal end portion connected to said peripheral portion; and
a distal end portion coupled to said proximal end portion.

11. A low friction control servo according to claim 10 further comprising a spring disposed in said housing, said spring contacting said distal end portion to bias said curved aim toward the open position.

12. A low friction control servo according to claim 111 wherein said actuator engages said distal end portion to hold said curved aim in a desired position.

13. A low friction control servo according to claim 1 wherein said curved arm is coiled.

14. A low friction control servo, comprising:
a housing having an inlet and an outlet;
a flexible valve plate, comprising:
a peripheral portion fixedly coupled to said housing; and
an inner portion coupled to said peripheral portion, said inner portion including at least one curved aim configured to flex axially relative to said peripheral portion between an open position and a closed position; and
an actuator coupled to said housing and configured to selectively hold said inner portion in the closed position.

15. A low friction control servo according to claim 14 wherein said inner portion is substantially coplanar with said peripheral portion when said curved arm is in the closed position.

16. A low friction control servo according to claim 14 wherein said inner portion is substantially axially displaced from said peripheral portion when said curved arm is in the open position.

17. A low friction control servo according to claim 14 further comprising a spring biasing said curved arm toward the open position.

18. A low friction control servo, comprising:
a housing having an inlet and an outlet;
a stopper;
a flexible valve plate, comprising:
a peripheral portion fixedly coupled to said housing; and
an inner portion coupled to said peripheral portion, said inner portion including a curved arm having said stopper attached thereto, said curved arm configured to flex axially relative to said peripheral portion between (i) a closed position wherein said stopper covers said outlet, and (ii) an open position;
a spring disposed in said housing and biasing said flexible valve plate toward the open position; and
an actuator coupled to said housing and configured to selectively hold said inner portion in the closed position.

19. A low friction control servo according to claim 18 wherein said stopper is attached to a medial portion of said curved arm, and wherein said actuator contacts a distal portion of said curved arm.

20. A low friction control servo according to claim 18 wherein said curved arm includes a first face and a second face opposite said first face, and wherein said stopper is attached to said first face, said spring contacts said first face, and said actuator contacts said second face.
